(19) United States
(12) Patent Application Publication
(10) Pub. No.: US 2008/0089979 A1
(43) Pub. Date: Apr. 17, 2008

(54) METHOD OF IMPROVING GAS CELL FORMATION OF FROZEN DESSERTS

(76) Inventor: James T.C. YUAN, Boothwyn, PA (US)

Correspondence Address: AIR LIQUIDE;Intellectual Property, 2700 POST OAK BOULEVARD, SUITE 1800, HOUSTON, TX, 77056, US

(21) Appl. No.: 11/695,482

(22) Filed: Apr. 2, 2007

Related U.S. Application Data
(60) Provisional application No. 60/843,997, filed on Sep. 12, 2006.

(51) Int. Cl. A23G 9/04; A23G 9/20; A23G 9/26; A23L 3/36

(52) U.S. Cl. 426/66; 426/524

(57) ABSTRACT

Processes for maintaining the stability and quality of frozen desserts during storage and transportation including an improvement. This improvement process involves introducing a gas mixture into the dispersed phase of the frozen dessert. This gas mixture may be a low molecular weight gas mixture or a high molecular weight gas mixture. The weight gas mixture would allow the cells within the frozen dessert to remain at approximately a constant volume during elevation changes, thereby reducing or eliminating shrinkage and transportation settling.

### CROSS REFERENCE TO RELATED APPLICATIONS

This application claims the benefit of U.S. Provisional Application No. 60/843,997, filed Sep. 12, 2006, the entire contents of which are incorporated herein by reference.

### BACKGROUND

Ice cream is, essentially, a foam consisting of air bubbles dispersed in a mixture of fat, water, and ice crystals. The air fraction is typically around 50% by volume, and this is crucial for the product to have the consistency and texture desired by customers.

The term “overrun”, is used to indicate how much air a particular ice cream contains. It is basically the ratio of the volume of the ice cream, less the volume of the liquid ice cream mix, divided by the volume of the liquid ice cream mix. So, if 50% of the volume of the ice cream is air, one would say that it had a 100% overrun.

U.S. federal standards limit the amount of air by specifying that a liter of ice cream must weigh at least 0.54 kilograms. U.S. ice creams typically do not contain over 100% overrun. Regular, to premium ice cream, generally has 80-100% overrun, and super premium ice cream often has 20%-50% overrun.

While recognizing that this large percentage of air must be incorporated into the final ice cream product, the main aim of ice cream manufacturing is to incorporate the smallest sizes and largest numbers of air bubbles, ice crystals, and fat globules into an aqueous phase.

However, these colloidal components are inherently unstable, which leads to problem with maintaining the stability of ice cream structure, subsequent to manufacture.

In recent times, the stability of air cells within the ice cream product during storage and transportation, has been studied extensively by researchers. Sofjan and Hartel investigated the effect of overrun on air cell stability, and demonstrated that higher overrun led to slightly more stable air cells during storage. On the other hand, Chang and Hartel, as explained in their various publications, have studied the effects of operating conditions and formulation, as well as the type, level of emulsifier, and stabilizer on the development of air cells during storage and hardening of dairy foams.

Commercially, different stabilizers, such as alginates, guar, locus bean, xanthan, carrageenan, and chemically modified cellulose gums (carboxymethylcellulose, CMC) are being used in combination. It has been found that this provides a more stable emulsion and helps prevent air bubble collapse/shrinkage during storage or transportation. Emulsifiers, such as a blend of propylene glycol monostearate, sorbitan tristearate, and unsaturated monoglycerides, EDTA, proteose peptone whey fraction, a mix of mono- and diglycerides (MDG), alone, or in combination with polysorbates, as well as polyglycerols and lecithin (or egg yolk), have also been used. These tend to establish and maintain a more stable structure around the air-cell walls. The incorporation of surfactants, such as Tween 60, has been shown to be effective in stabilizing air cells in ice creams.

While ice cream has been discussed in detail, related issues are also found with the stability of other frozen desserts.

There is a need in the industry for a method to improve the stability and quality of frozen desserts.

### SUMMARY

The process in the present application is directed to a method to improve the stability and quality of frozen desserts.

In one aspect, a method of improving the gas cell formation of aerated frozen desserts is provided. This method uses granular dry ice that is introduced into the dispersed phase of the frozen dessert.

### DESCRIPTION OF PREFERRED EMBODIMENTS

The present invention incorporates dry ice powder or granules into the dispersed stage of an aerated frozen dessert. Due to the extremely cold temperatures of the dry ice (−109.3° F.), the dry ice can freeze the frozen dessert mix very quickly and therefore improve the product throughput. While the dry ice powder or granules are entrapped in frozen or near-frozen dessert mix, they will sublimate and create gas cells within the frozen dessert. Since carbon dioxide is heavier than air, these gas cells (and hence the aerated frozen dessert) will be more stable during transportation or during periods of cold storage. Since the dry ice treatment creates gas cells in the frozen dessert in-situ, the throughput of the product will be improved.

In one embodiment, the granular dry ice is injected into the frozen dessert in a continuous motion, or in constant intervals. In one embodiment, the granular dry ice is injected into the frozen dessert in batches.

The granular dry ice may be introduced into the frozen dessert by any means known to the skilled artisan. Examples include, but are not limited to, venturi introduction, sparging, and through ambient mixing. The granular dry ice may be introduced from the top, bottom and/or from the sides.

The granular dry ice may be in the form of granules or in the form of a powder. The granule form of the dry ice may between 10 and 50 mesh (United States Standard Sieve Mesh). Preferably, the granular form of the dry ice may be between 20 and 40 mesh. Preferably, the granular form of the dry ice may be between 25 and 30 mesh. The powder form of the dry ice may be between 50 and 200 mesh. Preferably, the powder form of the dry ice may be between 60 and 100 mesh. Preferably, the powder form of the dry ice may be between 65 and 80 mesh.

The dry ice may be produced prior to the mixing step, or real-time contemporaneous with the mixing step.

The flow rate of the granular dry ice depends on the load of frozen desserts, and may range from a few ml/min to several liters/min. These frozen desserts may be of any type suitable for application of this method. Examples include, but are not limited to ice cream, ice milk, sorbet, frozen yogurt, frappe, frozen treats on sticks, parfait, sherbet, and water ice.

The dry ice can be in the form of a powder, granules, or a mixture of both. An inert gas may be added to the mixing step to improve the mixing rate. These inter gases may include air, carbon dioxide, nitrous oxide, argon, helium, nitrogen, krypton, xenon, neon, or any mixtures of the above.

Illustrative embodiments have been described above. While the process in the present application is susceptible to various modifications and alternative forms, specific embodiments thereof have been shown by way of example in the drawings, and have been herein described in detail. It should be understood, however, that the description herein of specific embodiments is not intended to limit the process in the present application to the particular forms disclosed, but on the contrary, the process in the present application is to cover all modifications, equivalents, and alternatives falling within the spirit and scope of the process in the present application, as defined by the appended claims.

It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but, would nevertheless, be a routine undertaking for those of ordinary skill in the art, having the benefit of this disclosure.

What is claimed is:

1. A method for improving air cell formation of aerated frozen desserts, comprising: introducing granular dry ice into the dispersed phase of said frozen dessert.

2. The method of claim 1, wherein said granular dry ice may be in the form selected from the group consisting of a powder, a granule, or a mixture of powder and granules.

3. The method of claim 1, further comprising the step of adding an inert gas to the mixing step to improve the mixing rate, wherein said inert gas comprises one or more of the gases selected from the group consisting of:
a) air;
b) carbon dioxide;
c) nitrous oxide;
d) argon;
e) helium:
f) nitrogen:
e) krypton;
f) xenon;
g) neon; or
h) mixtures thereof.

4. The method of claim 1, wherein said granular dry ice is introduced in a continuous manner.

5. The method of claim 4, wherein said continuous manner comprises a series of introductions at constant intervals of time.

6. The method of claim 1, wherein said granular dry ice is introduced in a batch manner.

7. The method of claim 1, wherein said granular dry ice is introduced from the top.

8. The method of claim 1, wherein said granular dry ice is introduced from the bottom.

9. The method of claim 1, wherein said granular dry ice is introduced from one or more sides.

10. The method of claim 1, wherein said granular dry ice is produced immediately prior to the introduction.

11. The method of claim 1, wherein said aerated frozen dessert is selected from the group consisting of:
a) ice cream;
b) ice milk;
c) sorbet;
d) frozen yogurt;
e) frappe;
f) frozen treats on sticks;
g) parfait;
h) sherbet; and
i) water ice.
h) sherbet; and
i) water ice.
